(19) United States
(12) Patent Application Publication
(10) Pub. No.: US 2012/0256109 A1
(43) Pub. Date: Oct. 11, 2012

(54) Magnetic Valve and Driver Assistance Device having such a Magnetic Valve

(75) Inventors: Harald Guggenmos, Immenstadt/Seifen (DE); Michael Dinerman, Heilbronn (DE); Friedrich Mueller, Immenstadt (DE); Anton Fritz, Ofterschwang (DE); Elmar Vier, Freiberg A.N. (DE)

(73) Assignee: Robert Bosch GmbH, Stuttgart (DE)

(21) Appl. No.: 13/518,345

(22) PCT Filed: Oct. 28, 2010
(86) PCT No.: PCT/EP2010/066315

§ 371 Date: Jun. 21, 2012

(30) Foreign Application Priority Data
Dec. 23, 2009 (DE) 10 2009 055 279.0

(51) Int. Cl. F16K 31/06

(52) U.S. Cl. 251/129.03

(57) ABSTRACT

A magnetic valve includes a main body and a closure element, which is connected to an end region of the main body and which can be impinged by a fluid pressure. The main body has at least one first support surface allocated to the closure element in the end region thereof. A support element is provided, which is connected to the main body and has at least one other second support surface serving as a bearing surface or forms the bearing surface together with the first support surface. The bearing surface is larger than the first support surface.

The invention relates to a solenoid valve with a basic body and with a closing element adjoining an end region of the basic body and capable of being acted upon with a fluid pressure, the basic body having in its end region at least one first supporting surface assigned to the closing element. The invention relates, furthermore, to a driver assistance device.

### PRIOR ART

Solenoid valves of the type initially mentioned are known from the prior art. They are designed, for example, as currentlessly open or currentlessly closed 2/2-way solenoid valves. Such a solenoid valve serves as a technical component for controlling an inlet or outlet of gases or liquids or for controlling or regulating a flow direction. An inlet connection, through which the fluid, that is to say either gas or liquid, enters the solenoid valve, is often arranged in the closing element which adjoins the basic body or the end region of the latter. A force caused by the pressure of the fluid therefore acts upon the closing element. This force is caused, for example, by a pressure difference, particularly when the solenoid valve is closed, or by surfaces of the closing element which are of different size and are acted upon with the fluid. This force has to be absorbed by the basic body.

For this purpose, the latter has the first supporting surface which is assigned to the closing element. The supporting surface serves for supporting the closing element in the axial direction, particularly when the force urge the closing element toward the basic body. A very high pressure may be exerted upon the closing element or the basic body as the function of the force. This pressure is dependent on the area of the supporting surface. The support, known from the prior art, of the closing element on the basic body via the supporting surface may sometimes lead to a reduced fatigue strength of the solenoid valve, so that this possibly has to be exchanged more frequently.

### DISCLOSURE OF THE INVENTION

By contrast, the solenoid valve having the features mentioned in claim 1 has the advantage that the fatigue strength of the solenoid valve is improved. This is achieved, according to the invention, by means of a supporting element which is connected to the basic body and which has at least one further, second supporting surface serving as a bearing surface for the closing element or together with the first supporting surface forms the bearing surface, the bearing surface being larger than the first supporting surface. Thus, the pressure which is exerted upon the closing element by the fluid can be reduced by the amount by which the area of the bearing surface is larger than the area of the supporting surface. For this purpose, the supporting element is fastened to the basic body. Said supporting element has the second supporting surface. The latter may serve, in a first embodiment, as the sole bearing surface for the closing element. For example, in this case, the supporting element itself is supported on the supporting surface of the closing element and makes available the second supporting surface for supporting the closing element in the axial direction. In a second embodiment, the second supporting surface forms together with the first supporting surface the bearing surface. For this purpose, the second supporting surface is arranged flush or in alignment with the first supporting surface, so that together they form a planar surface, to be precise the bearing surface. This has a larger area than the first supporting surface.

In a development of the invention, the supporting element is connected to the basic body and/or to the closing element in a positive, nonpositive and/or materially integral manner. Basically, the supporting element may be connected in any way to the basic body or to the closing element. The supporting element is usually pressed onto the basic body, so that there is a nonpositive connection. In this case, the bearing surface usually serves merely for supporting the closing element. The fastening of the closing element to the basic body does not have to be achieved by fastening the closing element to the supporting element.

In a development of the invention, the supporting element lies at least in regions on the supporting surface of the basic body and/or in a groove formed in the region of the supporting surface. In order to fasten the supporting element itself in the axial direction, there may be provision for it to be supported at least in regions on the supporting surface of the basic body. This means that the supporting element lies on the supporting surface and via the supporting surface introduces into the basic body a force acting upon the supporting element. Alternatively or additionally, a groove, by means of which the axial fastening of the supporting element is implemented, can also be formed in the region of the (first) supporting surface. The groove is in this case a groove which is encircling at least in regions, in particular completely, and by means of which, for example, a latching connection between the supporting element and basic body is implemented. The groove also at the same time makes it easier to orient the first supporting surface with respect to the second supporting surface.

In a development of the invention, the second supporting surface is of annular design and/or frames the first supporting surface. Basically, the second supporting surface may have any shape. Usually, however, the basic body of the solenoid valve is cylindrical, that is to say has a cross section which at least in regions is round. For this reason, the second supporting surface is advantageously annular. In the second embodiment in which the second supporting surface forms together with the first supporting surface the bearing surface, there may be provision for the second supporting surface to frame the first supporting surface at least partially in the circumferential direction. Advantageously, the second supporting surface is designed as a ring completely surrounding the first supporting surface.

In a development of the invention, the closing element and/or the supporting element are/is composed of plastic and/or metal. The material for these elements is selected as a function of the force acting upon the closing element or the supporting element. In the case of low load, for example, it may be advantageous to use plastic both for the closing element and for the supporting element for reasons of cost. Under higher pressure load, however, the supporting element, in particular, may be formed from metal.

In a development of the invention, the supporting element engages at least in regions into a central recess of the basic body, in particular is held between the basic body and a sealing body of the solenoid valve, or surrounds the basic body at least in regions. In order to fasten the supporting element to the basic body basically two possibilities are therefore provided. The first possibility provides for the supporting element to engage into the basic body; in the second possibility, the basic body is surrounded by the supporting element. In this case, in particular, clamping fastening of the supporting element to the basic body is provided. For example, in the first possibility, the supporting element may be slightly larger than the central recess of the basic body into which said supporting element engages. Alternatively, if the supporting element surrounds the basic body, internal dimensions of the supporting element are slightly smaller than external dimensions of the basic body, so that a clamping hold is implemented.

If the supporting element is to engage into the central recess, it is especially advantageous if it is held by clamping between the basic body and a sealing body of the solenoid valve. The sealing body is provided in the solenoid valve, for example, to form a valve seat which co-operates with a sealing element in order to open or to close the solenoid valve. There may be provision, then, whereby, first, the supporting element is introduced into the central recess of the basic body, and then the sealing body is pressed into the supporting element in such a way that the latter expands at least slightly and a clamping connection to the basic body is thus made. Both the supporting element and the sealing body are thereby held in the solenoid valve or in the basic body. In such a version, however, it is advantageous if additional holding means are provided in order to secure the connection between the supporting element, sealing body and basic body permanently.

In a development of the invention, a housing of the solenoid valve frames at least in regions the basic body, the supporting element and/or the closing element. The housing is intended, in particular, to fasten the solenoid valve to an external device or to connect it to the latter. For this purpose, said housing frames at least the basic body at least in regions. Additionally or alternatively, there may also be provision for the supporting element or the closing element to be arranged at least in regions in the housing. The leaktightness of the solenoid valve and the fastening of the basic body, supporting element and closing element to one another are thereby improved.

In a development of the invention, the closing element is arranged outside the housing. In this case, therefore, the housing frames, for example, only the basic body and/or the supporting element. By contrast, the closing element is provided outside the housing. In this case, there may be provision for the closing element to be connected either to the basic body, the supporting element and/or the housing so as to implement the fastening of the closing element to the solenoid valve.

In a development of the invention, at least one fluid connection is formed in the basic body and/or in the closing element and/or the closing element forms the fluid connection. The fluid connection may, for example, be the inlet connection or else an outlet connection of the solenoid valve. For example, the inlet connection may be formed in the closing element and the outlet connection may be formed in the basic body. In this case, there may be provision for the closing element to form the fluid connection, that is to say to directly have means for making a fluid connection between an external device and the solenoid valve.

The invention relates, furthermore, to a driver assistance device, in particular ABS, TCS or ESP device, with at least one solenoid valve, particularly according to the above versions, which has a basic body and a closing element adjoining an end region of the basic body and capable of being acted upon with a fluid pressure, the basic body having in the end region a first supporting surface for supporting the closing element. In this case, a supporting element is provided which is connected to the basic body and which has a further, second supporting surface serving as a bearing surface for the closing element or together with the first supporting surface forms the bearing surface, the bearing surface being larger than the first supporting surface. The solenoid valves described above are suitable especially for use in such a driver assistance device, since, in such as this, high pressures, for example brake pressures, are often to be set by means of the solenoid valve. For example, the solenoid valves are in this case assigned to braking devices which belong to the driver assistance device or are at least activated by the latter.

The invention is explained in more detail below by means of the exemplary embodiments illustrated in the drawing, without any restriction occurring. In the drawing:

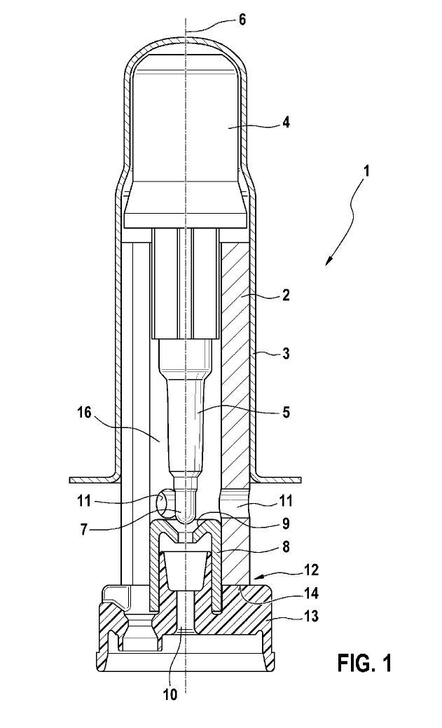

FIG. 1 shows a cross section of a solenoid valve not according to the invention which has a basic body and a closing element,

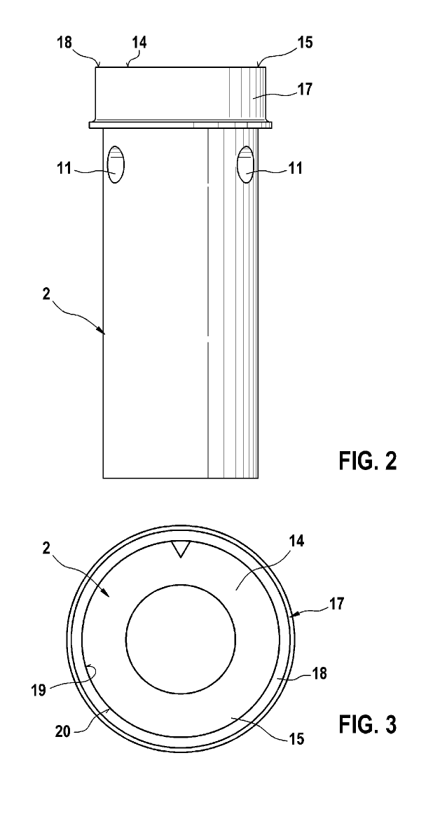

FIG. 2 shows the basic body of the solenoid valve in an embodiment according to the invention in a side view, a supporting element being mounted on the basic body, and

FIG. 3 shows the basic body with the supporting element in a top view, a bearing surface formed by supporting surfaces of the supporting element and of the basic body being visible.

FIG. 1 shows a sectional side view of a solenoid valve 1 which is known from the prior art in the embodiment illustrated here. The solenoid valve is composed of a basic body 2 which is designated also as a valve insert. The basic body 2 is enclosed at least in regions by a housing 3. A magnet armature 4 and an actuation element 5 adjoining the latter are mounted in the basic body 2 axially movably with respect to a longitudinal axis 6 of the solenoid valve 1. The actuation element 5 has on its side facing away from the magnet armature 4 a sealing element 7 which co-operates with a valve seat 9 formed in a sealing body 8 in order to make or brake a flow connection from a first fluid connection 10, which is designed as an inlet connection, to a second fluid connection 11, which constitutes an outlet connection.

In an end region 12 of the basic body 2, a closing element 13 adjoins the latter. In this case, the first fluid connection 10 is provided in this closing element 13 or is formed by the closing element 13. The closing element 13 is supported in the axial direction on a first supporting surface 14 which is formed by the basic body 2. This first supporting surface 14 in this case forms a bearing surface 15 for the closing element 13. Particularly when the solenoid valve 1 is closed, that is to say the sealing element 7 is seated in the valve seat 9 in such a way that there is no fluid communication between the fluid connections 10 and 11, a higher pressure is present at the first fluid connection 10 than at the second fluid connection 11 or in a fluid chamber 16. The fluid chamber 16 is in this case in permanent flow communication with the second fluid connection 11 and is formed or surrounded at least in regions by the basic body 2.

When the higher pressure is present at the first fluid connection 10, the closing element 13 is urged in the direction of the basic body 2 by this pressure. The pressure difference between the fluid connections 10 and 11 thus gives rise to a force upon the closing element 13 in the direction of the basic body 2. This force is absorbed by the bearing surface 15, both the basic body and the closing element 13 being exposed to a corresponding pressure or tension. In the embodiment of the solenoid valve 1 illustrated here, the area of the bearing surface 15 is comparatively small, so that a comparatively high pressure is applied to the basic body 2 and the closing element 13. Since the closing element 13 is usually composed of plastic, this may give rise to surface stress or surface load which is detrimental to the fatigue strength of the solenoid valve 1, since it may sometimes cause damage to the closing element 13.

For this reason, the basic body 2 in which the fluid connections 11 are present is assigned a supporting element 17 which is connected to the basic body 2. This is illustrated in FIG. 2. The supporting element 17 forms a further, second supporting surface 18 which is arranged flush or in alignment with the first supporting surface 14. The supporting surfaces 14 and 18 can thus together form a bearing surface 15 which has a larger area than the first supporting surface 14. In such an embodiment of the solenoid valve 1, the pressure which acts upon the closing element 13 lying on the bearing surface 15 is markedly reduced. The operational durability of the solenoid valve is thereby reduced by the reduction in the surface load of the closing element 13. The supporting element 17 may therefore also be designated as a reinforcing part.

As can be seen in FIG. 3, the supporting element 17 is of annularl design and completely surrounds the basic body 2 in the circumferential direction. In this case, the supporting element 17 is, for example, pressed onto the basic body 2, so as to make between an inner face 19 of the supporting element 17 and an outer face 20 of the basic body 2 a clamping connection via which the supporting element 17 is held securely on the basic body 2.

In this case, as already stated above, the first supporting surface 14 of the basic body 2 and the second supporting surface 18 of the supporting element 17 are arranged flush or in alignment with one another so as to form the bearing surface 15 for the closing element 13, the bearing surface 15 therefore being of planar form. It becomes clear that, by the supporting element 17 being provided, the bearing surface 15 is markedly enlarged, as compared with the solenoid valves 1 known from the prior art. Thus, the pressure acting upon the closing element 13 or the tensions in the closing element 13 which are caused by said pressure can be reduced, since the force upon the closing element 13 caused by the pressure of the fluid is applied to a larger area, to be precise to the joint area of the supporting surfaces 14 and 18. Solenoid valves 1 of this type can be used especially advantageously in conjunction with driver assistance devices, for example ABS, TCS or ESP devices.

1. A solenoid valve comprising:
a basic body;
a closing element adjoining an end region of the basic body; and
a supporting element connected to the basic body,
wherein the closing element is capable of being acted upon with a fluid pressure,
wherein the basic body having includes in its end region at least one first supporting surface assigned to the closing element,
wherein the supporting element includes at least one further, second supporting surface configured (i) to serve as a bearing surface or (ii) together with the first supporting surface forms the bearing surface, and
wherein the bearing surface being is larger than the first supporting surface.

2. The solenoid valve as claimed in claim 1, wherein the supporting element is connected to the basic body and/or to the closing element in a positive, nonpositive and/or materially integral manner.

3. The solenoid valve as claimed in claim 1, wherein the supporting element lies at least in regions on the supporting surface of the basic body and/or in a groove formed in the region of the supporting surface.

4. The solenoid valve as claimed in claim 1, wherein the second supporting surface is of annularl design and/or frames the first supporting surface.

5. The solenoid valve as claimed in claim 1, wherein the closing element and/or the supporting element are/is composed of plastic and/or metal.

6. The solenoid valve as claimed in claim 1, wherein the supporting element engages at least in regions into a central recess of the basic body or surrounds the basic body at least in regions.

7. The solenoid valve as claimed in claim 1, wherein a housing of the solenoid valve frames at least in regions the basic body, the supporting element and/or the closing element.

8. The solenoid valve as claimed in claim 1, characterized by wherein the closing element is arranged outside the housing.

9. The solenoid valve as claimed in claim 1, wherein at least one fluid connection is formed in the basic body and/or in the closing element and/or the closing element forms the fluid connection.

10. A driver assistance device, comprising:
at least one solenoid valve, including (i) a basic body (ii) a closing element adjoining an end region of the basic body and (iii) a supporting element connected to the basic body,
wherein the closing element is capable of being acted upon with a fluid pressure,
wherein the basic body having includes in the end region a first supporting surface for supporting the closing element,
wherein the supporting element includes a further, second supporting surface serving configured (i) to serve as a bearing surface for the closing element or (ii) together with the first supporting surface forms the bearing surface, and
wherein the bearing surface is larger than the first supporting surface.
